(19) United States
(12) Patent Application Publication
(10) Pub. No.: US 2014/0308651 A1
(43) Pub. Date: Oct. 16, 2014

(54) 3-D Interactive Tattoo Practice Skin

(71) Applicant: Robert Henry McClurg, JR., Las Vegas, NV (US)

(72) Inventor: Robert Henry McClurg, JR., Las Vegas, NV (US)

(21) Appl. No.: 13/863,076

(22) Filed: Apr. 15, 2013

(51) Int. Cl. G09B 19/24

(52) U.S. Cl. CPC G09B 19/24
USPC 434/377

(57) ABSTRACT

A tattoo-able practice prosthetic device may be worn to protect the wearer of a permanent mark, while allowing tattoo student to begin to understand the art of tattooing, by leaving that permanent mark on a non-permanent device.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of prosthetics. More particularly, the present invention is in the technical field of tattoo practice skin.

Conventional tattoo image practice devices, do not provide the user with a prosthetic grade, 3 dimensional way of simulating realistic tattooing experiences. This invention allows the “tattoo recipient” to wear the prosthetic as a second skin, while still preventing the wearer, from actually being permanently marked, then removing the present invention.

### SUMMARY OF THE INVENTION

The present invention is a tattoo-able device for users to insert the designated body part into the corresponding present invention, to simulate the act of a more permanent form of indelible marking of the body. Once simulation has concluded, present invention wearer may simply shrug off present invention, to find no permanent marking on their physical bodies.

### BRIEF DESCRIPTION OF THE DRAWING

FIG. 1 is a perspective view of the prosthetic device foam latex plug, needed to create the present invention.

FIG. 2 is a side view of the prosthetic device foam latex plug sculpture, needed to create present invention.

FIG. 3 is a perspective view of a prosthetic device sculpture, needed to create present invention.

FIG. 4 is a perspective of the foam latex plug, with the present invention fitted on its body, with regard to present invention silicone rubber wall thickness.

FIG. 5 is a side view of the foam latex plug, with the present invention fitted on its body, with regard to present invention, silicone rubber wall thickness.

FIG. 6 is a perspective view of a prosthetic device sculpture, with retaining wall for 3 part molding process.

FIG. 7 is a perspective view of a prosthetic device sculpture, in the completed 1st stage of the 3-part molding process, comprised of 2 part condensation cure silicone.

FIG. 8 is a perspective view of a prosthetic device sculpture, in the completed 2nd stage of the 3-part molding process, comprised of 2 part condensation cure silicone.

FIG. 9 is a perspective view of all 3 completed components: Top mold half, Bottom mold half, and foam latex plug, which will then all fit together.

### DETAILED DESCRIPTION OF THE INVENTION

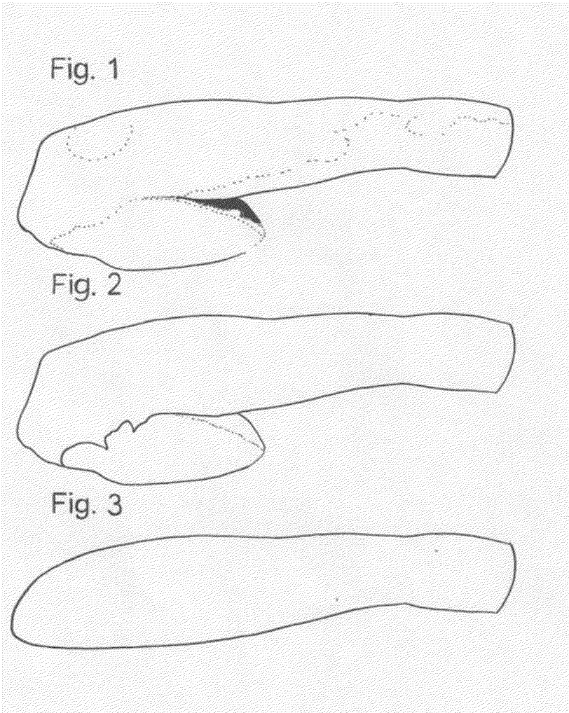

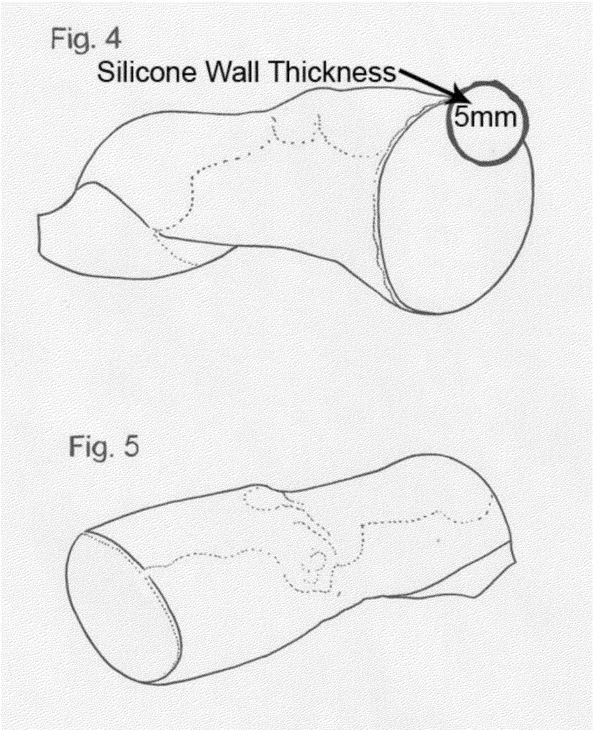

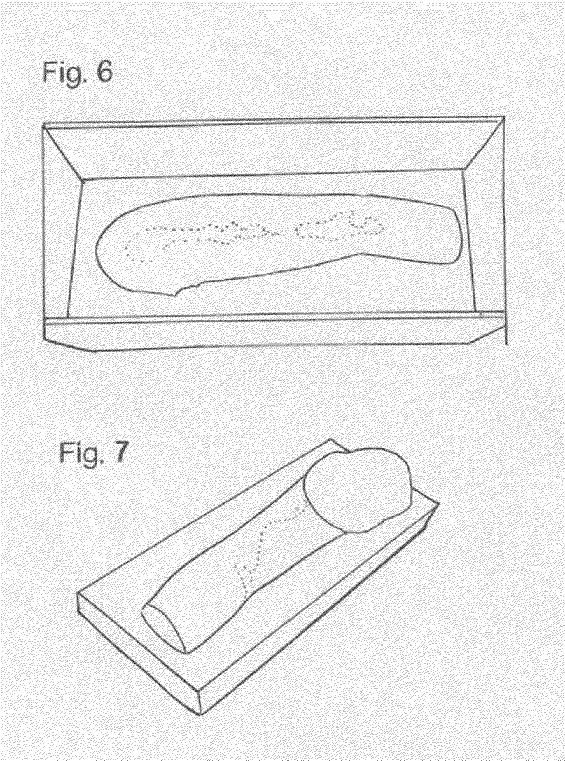

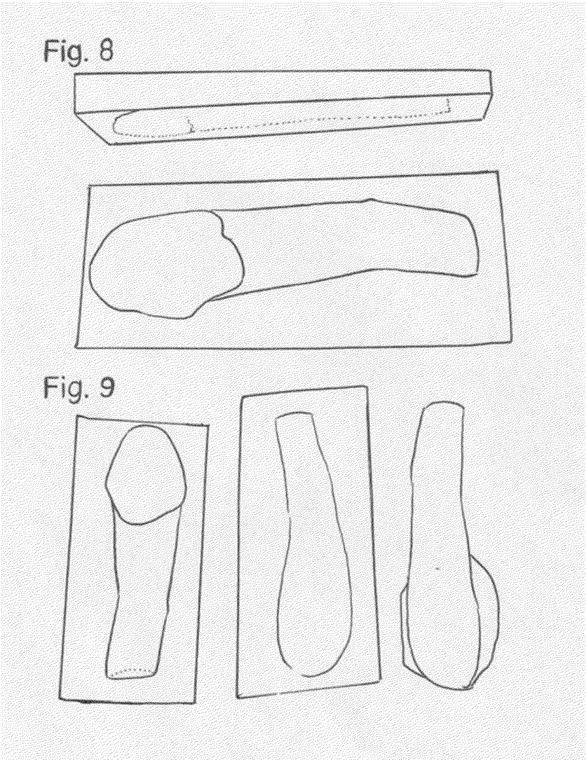

Referring now to the invention in more detail, in FIG. 4 and FIG. 5 there is shown an anatomical view of the device, still worn on the foam latex plug, as shown in FIG. 1. Prosthetic device is a one part device, Comprised of silicone rubber, which is a 2 part condensation cure silicone. Silicone pigment dispersions are used to color “skin”, available in special effects supply houses internationally, allowing for a more realistic overall aesthetic.

The construction details of the invention as shown in FIG. 9 are that of a 3 part mold, standard procedure of special effects (SFX) and prosthetic device manufacturers, producing 3 part molds, of oil based clay sculptures, which can be made of different materials, such as silicone rubber, Molding stone, metal, latex, & glass. The empty cavity that remains once these 3 pieces are fit together, allows for a softer formula of silicone rubber to be injected into the remaining cavity, once the 2-part silicone rubber has cured, the 3 mold pieces are slowly opened, to reveal present invention.

Referring now to FIG. 4 and FIG. 5, there is shown a silicone rubber “skin” comprised of a commonly available, 2 part condensation cure silicone. The 2 part silicone is then injected, via an industrial sized common plastic syringe, into the 3 part molds open cavity, as shown in FIG. 9, which is also known as manual injection casting.

The advantages of the present invention include, without limitation, the 3 dimensional hollow nature of its construction as shown in FIG. 9, FIG. 4, & FIG. 5 allows for superior tattoo simulation, for wearer, and practicing tattoo student, alike, making for a more hands on knowledge, of the art of tattooing, and its procedures for aseptic practice.

In broad embodiment, the present invention is a prosthetic that can be worn, practiced on by an artist, with pigments suitable for micro-dermal pigmentation, then removed by wearer, in licensed and health approved tattoo art studios, and licensed and health department certified tattoo artists, for instructional purposes at convention oriented venues.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A completely three dimensional sleeve to be worn by the tattoo instructor for the sake of tattoo instructional purposes, the student then tattoos the three dimensional sleeve that the instructor is wearing to simulate realistic tattooing experiences, the sleeve is then removed after procedure with no permanent marks made to the wearer of said sleeve.
